(19) United States
(12) Patent Application Publication
(10) Pub. No.: US 2015/0131803 A1
(43) Pub. Date: May 14, 2015

(54) MEETING MUTING

(71) Applicant: Lenovo (Singapore) Pte. Ltd., Singapore (SG)

(72) Inventors: Arnold S. Weksler, Raleigh, NC (US); Antonio Bumarch, III, Cary, NC (US); Neal Robert Caliendo, Jr., Raleigh, NC (US)

(73) Assignee: Lenovo (Singapore) Pte. Ltd., Singapore (SG)

(21) Appl. No.: 14/078,379

(22) Filed: Nov. 12, 2013

(51) Int. Cl. H04R 29/00

(52) U.S. Cl. CPC H04R 29/001
USPC 381/56

(57) ABSTRACT

A system can include a processor; memory operatively coupled to the processor; a microphone operatively coupled to the processor; a speaker operatively coupled to the processor; and circuitry that mutes the speaker based on detection of voices via the microphone. A method can include detecting two different voices via a microphone of a device; and responsive to the detecting, muting a speaker of the device. Various other apparatuses, systems, methods, etc., are also disclosed.

### TECHNICAL FIELD

Subject matter disclosed herein generally relates to notification mechanisms.

### BACKGROUND

Various devices, systems, etc. are configured to issue notifications via one or more notification mechanisms responsive to events. Various technologies and techniques described herein pertain to muting, for example, of one or more notification mechanisms.

### SUMMARY

A system can include a processor; memory operatively coupled to the processor; a microphone operatively coupled to the processor; a speaker operatively coupled to the processor; and circuitry that mutes the speaker based on detection of voices via the microphone. A method can include detecting two different voices via a microphone of a device; and responsive to the detecting, muting a speaker of the device. Various other apparatuses, systems, methods, etc., are also disclosed.

### BRIEF DESCRIPTION OF THE DRAWINGS

Features and advantages of the described implementations can be more readily understood by reference to the following description taken in conjunction with examples of the accompanying drawings.

FIG. 1 is a diagram of an example of an environment in which a meeting is taking place;

FIG. 2 is a diagram of an example of a method;

FIG. 3 is a diagram of example of a device;

FIG. 4 is a series of diagrams of examples of systems;

FIG. 5 is a series of diagrams of examples of methods;

FIG. 6 is a series of diagrams of examples of devices and examples of states;

FIG. 7 is a diagram of an example of a method; and

FIG. 8 is a diagram of an example of a system that includes one or more processors.

### DETAILED DESCRIPTION

The following description includes the best mode presently contemplated for practicing the described implementations. This description is not to be taken in a limiting sense, but rather is made merely for the purpose of describing general principles of various implementations. The scope of invention should be ascertained with reference to issued claims.

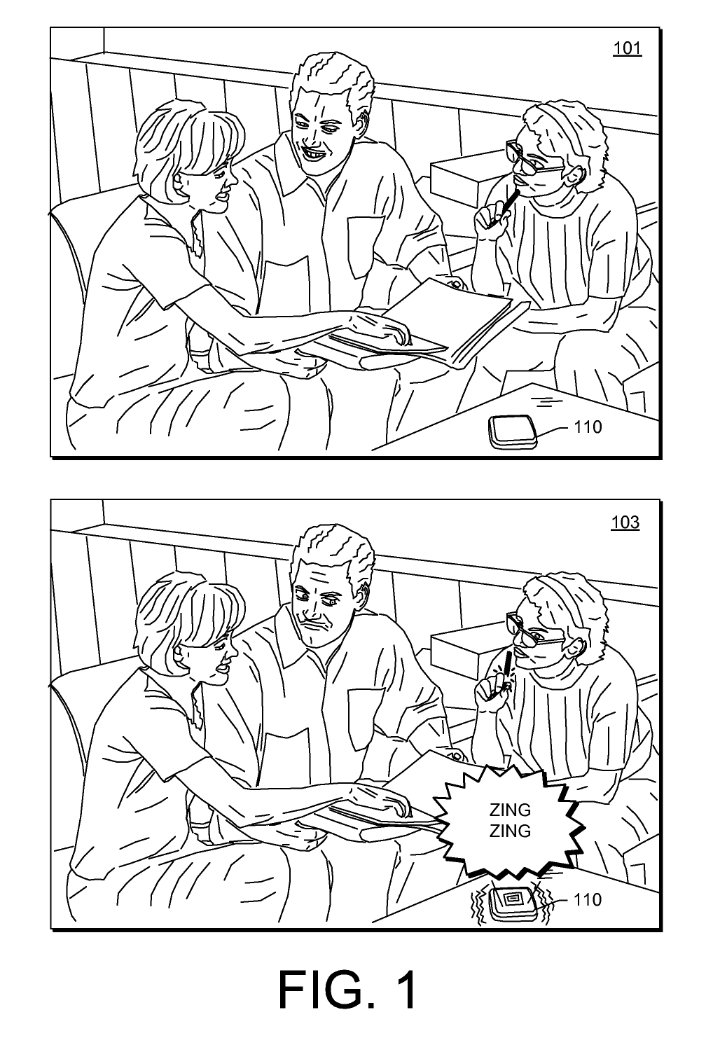

FIG. 1 shows an example of an environment in which a meeting is taking place between three individuals in the presence of a device 110. At a time represented in block 101, two of the individuals are speaking to each other while reviewing documents and the other individual is listening intently to their conversation. At a time represented in block 103, the device 110 starts to issue one or more notifications. For example, the device 110 may issue a ring tone, may vibrate, may illuminate its display, etc. As illustrated, the device 110 may be positioned on a surface of a table, a desk, etc. which may act to amplify sound, whether the sound is issued via a speaker or speakers of the device, caused by vibration of the device, etc. As indicated by expressions of two of the individuals, the device 110 is a distraction, which may interrupt and detract from the purpose of the meeting (e.g., effective listening, speaking, concentration, etc.).

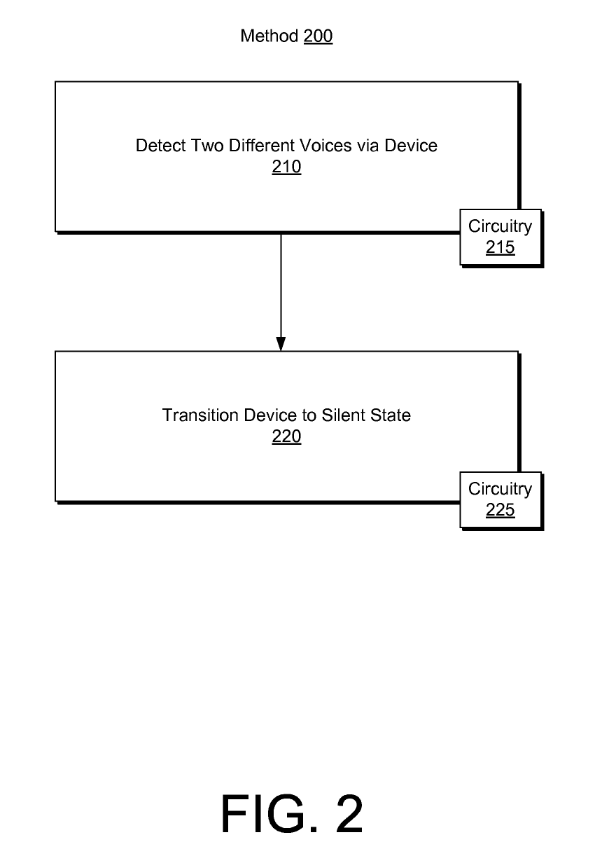

FIG. 2 shows an example of a method 200 that includes a detection block 210 for detecting two different voices via a device and a transition block 220 for transitioning the device to a silent state. In the example of FIG. 2, circuitry blocks 215 and 225 are also shown that represent circuitry for performing actions of the blocks 210 and 220. For example, the circuitry 215 may include a microphone and voice recognition circuitry that can recognize a voice, a number of voices, etc. via analysis of signals received via the microphone. As to the circuitry 225, it may include state logic that responds to output from the circuitry 215, for example, to transition a device from one state to another state, which may be, as an example, a so-called silent state (e.g., or muted state). As an example, a silent state may be a state where one or more notification mechanisms of a device may be adjusted, managed, disabled, etc. For example, a speaker that can issue an audio notification may be muted, a vibrator that can issue a mechanical notification may be disabled, a display that can issue a visual notification may be dimmed, etc. In such an example, a notification may be due to receipt of an email, an instant message, a phone call, an update to code (e.g., a software update), a calendar event, a reminder, etc. In the foregoing example, silencing or muting may refer to muting of a speaker, disabling of a vibrator, dimming of a display, etc. For example, silencing or muting may cause a speaker to be maintained in a silent or off state, a vibrator to be maintained in an unactuated or off state, a display to be maintained in a dim or off state, etc. One or more of such examples may be characteristics of a silent or muted state of a device or system.

As an example, the method 200, if implemented using circuitry of the device 110 of FIG. 1 (e.g., via circuitry such as the circuitry 215 and 225), may be able to avoid the disruption to the meeting as illustrated in the block 103. For example, the device 110 may sense audio signals via a microphone and analyze such signals to detect the presence of at least two different voices. In response, the device 110 may then transition to a state where its notification mechanisms (e.g., speaker, vibrator, display, etc.) are effectively silenced. In such an example, when the meeting terminates, the device 110 may fail to detect two different voices and, in response, transition to a different state, for example, where its notification mechanisms can respond, as appropriate, to signals from one or more applications (e.g., a phone application, an email application, an update application, an instant messaging application, a calendar application, a reminder application, etc.).

As an example, a method can include detecting two different voices via a microphone of a device; and, responsive to the detecting, muting a speaker of the device.

As illustrated in the example of FIG. 1, a device (e.g., a computer, information handling system, a device, a system, etc.) may make one or more disruptive sounds or other actions during a meeting, for example, because a user has forgotten to mute the device prior to the meeting (e.g., whether in an office or other environment). An institution may have a policy, for example, that meeting attendees are required to silence cell phones, computers, etc. prior to commencing a meeting. As an example, a method such as the method 200 of FIG. 2 may be an automatic method, for example, that acts to automatically mute a device if it detects a voice or voices (e.g., that can infer that a meeting is taking place, etc.). For example, a device such as the device 110 of FIG. 1 may include an automatic mute function that mutes the device if it detects a voice or voices. As to muting based on detection of a single voice, such an approach may include comparing one or more characteristics of a single voice to stored characteristics, for example, of an account holder of the device (e.g., owner, etc.). For example, where the voice is not that of the account holder, logic may infer that a meeting is taking place (e.g., based on a single voice). While a meeting is mentioned, such a function or functions may operate in other scenarios, environments, etc. For example, such a function or functions may be configured via circuitry to operate in a movie theatre or another setting, for example, where sound (e.g., or emission of light or mechanical vibration) may be found to be disruptive. As an example, logic may operate based in part on one or more user adjustable setting, sensed information from one or more sensors (e.g., a microphone and optionally one or more other sensors), etc.

As an example, a device may analyze sensed information and determine characteristics of a silent state based at least in part on such an analysis. For example, where an environment is a low light environment (e.g., a dimly lit meeting room), analysis of ambient light via an ambient light sensor may cause the device to refrain from illuminating its display (e.g., which could distract one or more meeting attendees). As mentioned, a single voice mode may be implemented, which may be suitable for a scenario where a meeting includes a speaker that is presenting information at least verbally. For example, based on a determination that the sensed single voice is not that of an account holder (e.g., owner, etc.) of the device, the device may transition to a silent state such that a device event does not cause a notification mechanism to issue one or more notifications that could detract the account holder or others.

As an example, a device may include an event summary option that presents a list of events that may have occurred while the device was in a silent state. As an example, a device may include circuitry to respond to an incoming message (e.g., email, phone, IM, etc.) while in a silent state, for example, to notify a sender that the device is in a silent state (e.g., via text or audio: “the person you are trying to reach is currently in a meeting”).

As an example, a system can include a processor; memory operatively coupled to the processor; a microphone operatively coupled to the processor; a speaker operatively coupled to the processor; and circuitry that mutes the speaker based on detection of voices via the microphone.

As an example, a system can include a speaker or a speaker output and circuitry that mutes the speaker or the speaker output based on detection of voices via a microphone or a microphone input; a vibrator and circuitry that disables the vibrator based on detection of voices via a microphone or a microphone input; and/or a display or a display output and circuitry that disables the display or the display output based on detection of voices via a microphone or a microphone input.

As an example, a method may provide for controlling a device or a system where the device or system can include a speaker or a speaker output and circuitry that mutes the speaker or the speaker output based on detection of voices via a microphone or a microphone input; a vibrator and circuitry that disables the vibrator based on detection of voices via a microphone or a microphone input; and/or a display or a display output and circuitry that disables the display or the display output based on detection of voices via a microphone or a microphone input. While the foregoing example mentions voices, as discussed, a method may implement logic that may, for example, infer a meeting is occurring based on detection of a single voice (e.g., a voice that is determined to be not that of an account holder of the device, etc.).

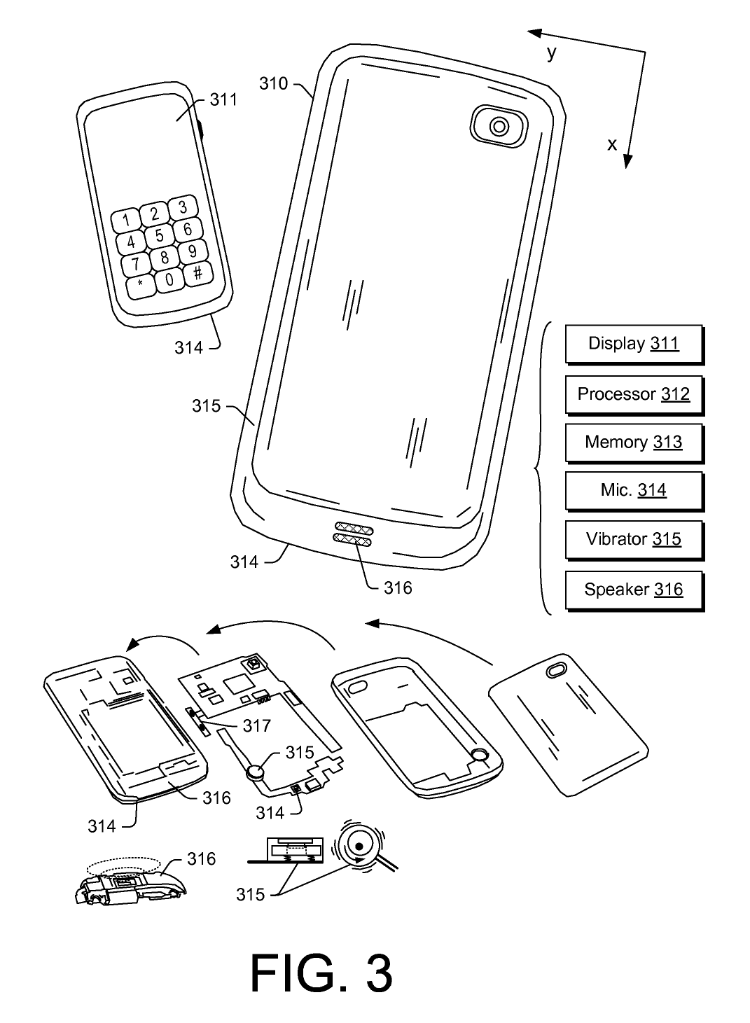

FIG. 3 shows an example of a mobile device 310 that includes a display 311, which may be a touch display (e.g., a touchscreen display) for input of information (e.g., via a key pad, control graphics, etc.) and output of information (e.g., with a resolution of about 1280×720 pixels and/or a density of about 300 pixels per inch). As shown, the mobile device 310 includes various components such as a processor 312, memory 313 operatively coupled to the processor 312, a microphone 314 operatively coupled to the processor 312, a vibrator 315 operatively coupled to the processor and a speaker 316 operatively coupled to the processor 312.

As an example, a device such as the device 310 may include a battery bay, display graphics circuitry (e.g., optionally including touch and gesture circuitry) a camera (e.g., configured for capturing still images, video, etc.), optionally auto-focus circuitry, optionally a flash for flash photography/videography, a SIM slot, a main processor, audio circuitry (e.g., for notifications such as ringtones, etc.), power management circuitry, motion processing circuitry (e.g., accelerometer, gyroscope), modem circuitry, pressure sensor circuitry, multi-band power amplification circuitry, memory (e.g., SDRAM, etc.), wireless LAN circuitry, smart card circuitry, transmitter circuitry, ambient light sensing circuitry, and GPS circuitry. As an example, a device such as the device 310 may include voice recognition circuitry (e.g., speech recognition circuitry), for example, as a feature for input of phone numbers, contact names, etc. As an example, a method may include implementing such circuitry for purposes of voice detection with respect to transitioning and/or maintaining a device in a silent state.

In the example of FIG. 3, the speaker 316 is located with respect to openings on a back side of the device 310 while the microphone 314 is located with respect to an opening on a lower side of the device 310. As an example, the openings for the speaker 316 may be along a sloped surface (e.g., curved surface) such that when the device 310 is positioned on a flat surface, the openings are not covered (e.g., or at least partially uncovered). As an example, a method may include determining whether a device is facing up or down on a surface and, in turn, adjusting one or more characteristics of a silent state based on such information. For example, if the device 310 is display side down, a silent state may account for an upwardly facing speaker (e.g., where sound may be projected outwardly) and a downwardly facing display (e.g., where illumination of the display may be assumed to not pose a distraction risk). The device 310 may include a volume control 317, for example, that may perform one or more different functions, for example, depending on the operational state of the device 310. As an example, a method that transitions a device to a silent state may include placing a volume control mechanism in a particular state (e.g., muted, lowest level setting, etc.). In the example of FIG. 3, the vibrator 315 is located proximate to one side of the device 310 and may include an eccentric rotatable mass or other type of movable mass.

As an example, the display 311 may be adjustable as to its brightness. For example, the device 310 may include display circuitry to dim the display 311, to brighten the display 311, etc. As an example, dimming the display 311 causes the display 311 to emit less light whereas brightening the display 311 causes the display 311 to emit more light. As an example, contrast may be taken into account for dimming or brightening, for example, based on brightness of an environment. For example, where an environment is dim, a dimly lit display may be adequately visible to a user; however, in some environments, even a dimly lit display may be a distraction (e.g., during a meeting accompanied by projection of information, visual display, etc.). As an example, an ambient light sensor may provide information as to luminous intensity, etc. of an environment.

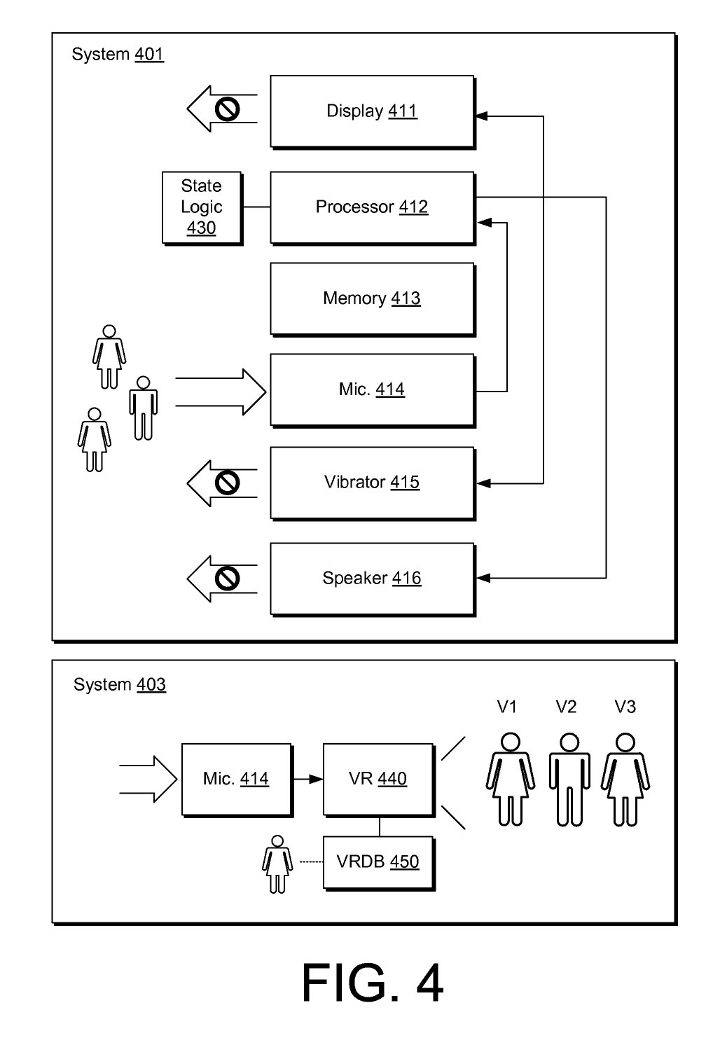

FIG. 4 shows an example of a system 401 and an example of a system 403. As shown, the system 401 can include a display 411, a processor 412 (e.g., where the display 411 is operatively coupled to the processor 412), memory 413 operatively coupled to the processor 412, a microphone 414 operatively coupled to the processor 412, a vibrator 415 operatively coupled to the processor and a speaker 416 operatively coupled to the processor 412. As shown, the system 401 can include state logic 430, for example, accessible by the processor 412 to place the system 401 in a particular state.

As indicated by various arrows, the system 401 may respond to detection of voices by transitioning to a state where changes to brightness of the display 411, vibration of the vibrator 415 and/or issuance of sound via the speaker 416 are disabled (e.g., prohibited). For example, the display 411 may be off and remain off while the system 401 determines that it is in an environment where voices are sensed via the microphone 414; the vibrator 415 may be not actuated and remain so; and the speaker 416 (e.g., or associated audio circuitry) may be in a silent state and remain so.

As to the system 403, it includes the microphone 414 as well as voice recognition (VR) circuitry 440 and optionally a voice recognition database (VRDB) 450. As an example, the system 403 may have recognized a user's voice (e.g., owner's voice, account holder's voice, etc.) and stored indicia of that voice in memory such as the VRDB 450. In such an example, the system 403 may be able to recognize a voice and determine that another, different voice is also present within a time frame representative of a conversation. For example, if two different voices are recognized within a period of the order of several minutes, the system 403 may transition to a silent state. As an example, such a period of time may be adjustable, for example, to comport with types of meetings that a user may attend.

As an example, a system may be configured to detect a user's voice and at least one different voice, which may be, for example, not the same voice over a period of time. For example, where V1 is the user's voice and where the system 403 detects a different voice, whether that of V2 or V3, the system 403 may transition to a silent state (e.g., optionally without making a determination as to whether V2 and V3 may be different voices with respect to each other). In such an example, the system may optionally infer that a meeting is taking place based on deciding that a voice is not that of the user of the system and, in turn, transition the system to a silent state.

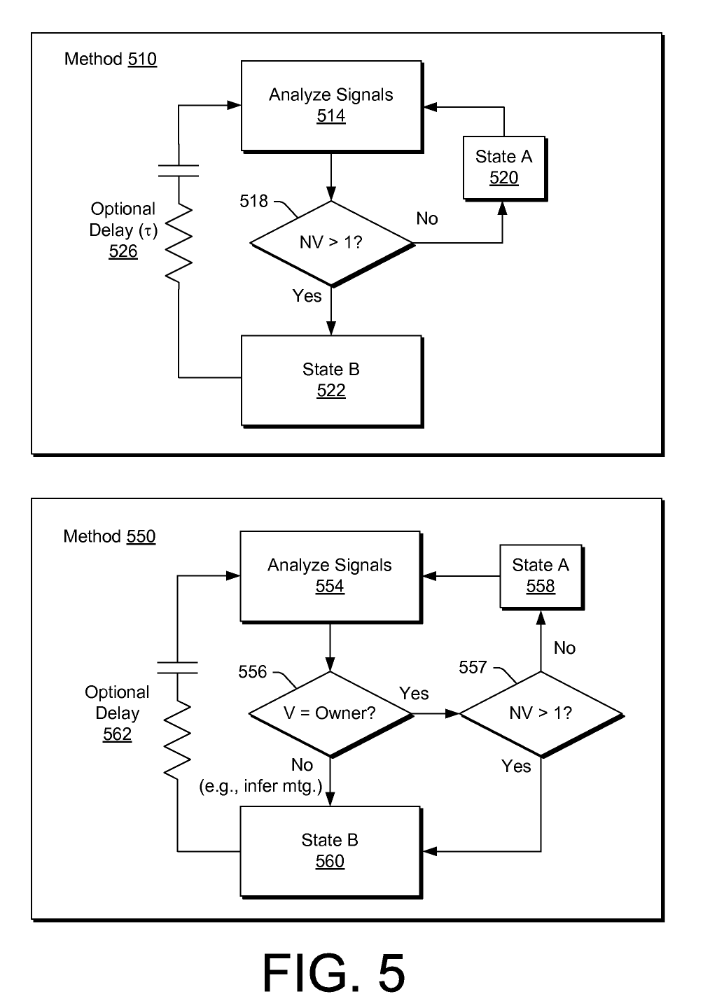

FIG. 5 shows an example of a method 510 and an example of a method 550. The method 510 includes an analysis block 514 for analyzing signals (e.g., via a microphone or microphones), a decision block 518 for deciding whether a number of voices (NV) exceeds one, a state block 520 for transitioning to or maintaining a state A and a state block 522 for transitioning to or maintaining a state B. For example, per the decision block 518, where the number of voices (NV) exceeds one, the method 510 may transition a device, a system, etc. to the state B via the state block 522, which may be a silent state; whereas, state A of the state block 520 may represent a different state, for example, where a speaker may make sound, a vibrator may vibrate, a display may increase in brightness, etc. The method 510 is also shown as including a return loop, which may include an optional delay 526 (e.g., a programmable time delay).

The method 550 includes an analysis block 554 for analyzing signals (e.g., via a microphone or microphones), a decision block 556 for deciding whether a voice (V) is that of an owner, a decision block 557 for deciding whether a number of voices (NV) exceeds one, a state block 558 for transitioning to or maintaining a state A and a state block 560 for transitioning to or maintaining a state B. For example, per the decision block 556, where a voice is not that of the owner, the method 550 may transition to a state B per the state block 560. For example, a method may include detecting a voice via a microphone of an information handling system; deciding whether the voice corresponds to that of an account holder of the information handling system; and, where the detected voice does not correspond to that of the account holder, mute a speaker of the information handling system. In such an example, by detecting a voice that is not that of an owner of a device, the device may infer that a meeting is taking place and transition the device into a silent state (e.g., by muting a speaker, disabling a vibrator, etc.). As an example, a method may include deciding whether a voice corresponds to that of an account holder of an information handling system and/or deciding whether a voice does not correspond to that of an account holder of the information handling system. In such an example, a decision may be made, for example, by comparing one or more signal characteristics to one or more stored signal characteristics that correspond to a voice of an account holder (e.g., an owner, a user, etc. of a device, system, etc.).

As another example, to avoid snooping, etc., the method 550 may place a device in a silent state such that the device refrains from issuing a notification or notifications in the presence of the person associated with a voice, which is in the absence of the owner's voice.

As shown in FIG. 5, in the method 550, where the decision block 556 decides that an owner's voice is detected, the method 550 can continue to the decision block 557, where if the number of voices (NV) exceeds one, the method 550 may transition a device, a system, etc. to the state B via the state block 560, which may be a silent state; whereas, state A of the state block 558 may represent a different state, for example, where a speaker may make sound, a vibrator may vibrate, a display may increase in brightness, etc. The method 550 is also shown as including a return loop, which may include an optional delay 562 (e.g., a programmable time delay).

As an example, a method may include determining that a voice is that same voice for an interval of time. For example, a method may include analyzing signals acquired via a microphone for an interval of time of the order of about ten seconds. Such an approach may provide for control of states while a user is walking down a street or moving in another environment where voices may be present. As an example, the block 514 of the method 510 and/or the block 554 of the method 550 may include storing signals acquired via a microphone, for example, where the signals correspond to an interval of time. In such an example, the interval of time may be a default amount of time or, for example, an adjustable amount of time that may be based on conversation patterns, etc. For example, an individual may engage in conversations of particular length, back-and-forth, etc. that may correspond to duties, tasks, etc. As an example, a device may include learning circuitry that can implement a learning algorithm (e.g., or training algorithm) that can acquire signals, analyze signals and adjust an interval of time associated with signal acquisition and/or signal analysis (e.g., as to recognition, cadence, patterns, differences, etc.) to improve reliability as to determining whether a meeting is in progress (e.g., to prevent false positives, etc.).

As an example, a method may include determining that a voice or voices correspond to speech. For example, a method may analyze signals acquired via a microphone to determine whether instrumental music is present, which may infer that a voice is part of music (e.g., a song).

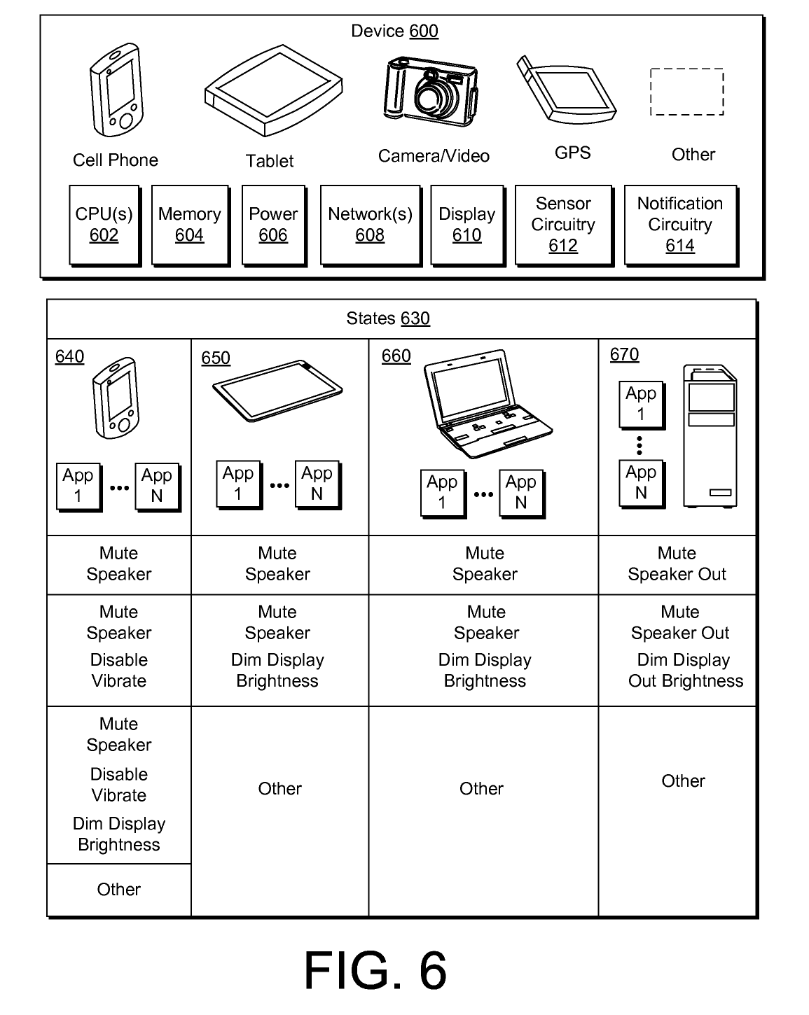

FIG. 6 shows an example of a device 600 and examples of states 630 as may be associated with various examples of devices 640, 650, 660 and 670 (e.g., or systems). As shown, the device 600 may be configured as a phone, a tablet, a camera, a GPS device or other device. As an example, the device 600 may include one or more processors 602, memory 604, a power source 606, one or more network interfaces 608, a display 610 (e.g., or displays), sensor circuitry 612 (e.g., including a microphone) and notification circuitry 614 (e.g., for a vibrator, a speaker, a display, etc.).

As to the states, for the devices 640, 650, 660 and 670, these may optionally be associated with one or more applications (e.g., App 1 to App N). For example, a device may include an operating system for establishing an operating system environment that can be used to execute an application. In such an example, the application may respond to an event by issuing a signal to cause circuitry of the device to make a sound, vibrate, increase display brightness, etc. As an example, a device may include one or more application programming interfaces (APIs) where an application may issue a call via such an interface and where the device may actuate circuitry in response to receipt of the call. For example, consider an API for audio circuitry to allow an application to respond to an event by causing a device to make a sound.

As an example, a device may include graphics circuitry (e.g., with an input and an output), audio circuitry (e.g., with an input and an output), network circuitry (e.g., with an input and an output), etc. As an example, various events may be processed, in part, by such circuitry, optionally in a relatively independent manner from a central processing unit (CPU). For example, consider network circuitry operatively coupled to audio circuitry where receipt of a signal via the network circuitry (e.g., whether wired or wireless) may cause the audio circuitry to output a signal to a speaker. In such an example, the audio circuitry may enter a silent state where voices have been detected, for example, within a time window such that the audio circuitry does not output a signal to the speaker. As an example, audio circuitry may include a microphone or microphones and/or an input for one or more microphones. As an example, audio circuitry may be self-regulating in that it can detect voices and place itself in a silent state (e.g., as to output via a speaker or speakers). As an example, such audio circuitry may be configured to output a signal that causes other circuitry (e.g., vibrator circuitry, display circuitry, etc.) to transition to or maintain a silent state. As mentioned, a silent state can include a state that can avoid increasing brightness of a display, avoid actuating of a vibrator, etc., as well as silencing audio circuitry configured to output signals to a speaker.

As to the states 630, they may include a mute speaker state, a mute speaker out state, a disable vibrate state, a dim display brightness state, a dim display out brightness state, and one or more other states, including, for example, combinations of states.

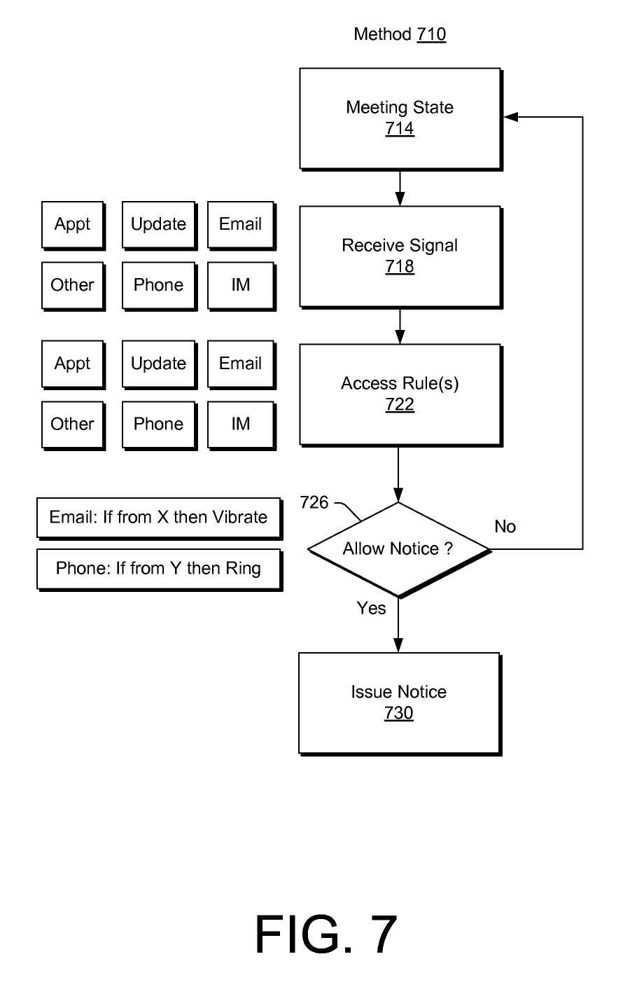

FIG. 7 shows an example of a method 710 that includes a state block 714 for transitioning to or maintaining a meeting state (e.g., where two voices have been detected in an environment), a reception block 718 for receiving a signal (e.g., at least in part via a microphone or microphone input circuitry), an access block 722 for accessing one or more rules (e.g., based on one or more characteristics of the signal), a decision block 726 to decide whether a notice should be allowed (e.g., to be issued) and an issue block 730 for issuing a notice, for example, if allowed per the decision block 726.

The method 710 is shown along with some examples of types of signals and with some examples of types of rules. For example, a particular rule might be associated with an email application such that: “If email from X then vibrate”. As another example, a particular rule might be associated with a phone application such that: “If call from Y then ring”. For example, even where a device (e.g., or system) may be in a silent state due to detection of a voice or voices (e.g., indicative of a meeting), one or more exceptions may exist. For example, if a call is received from a superior manager, that call may be an exception. In such an example, a device may include memory for storing rules, which may include rules as to exception (e.g., associated with types of application, times of day, address of a sender, phone number of a caller, etc.).

As an example, a system can include a processor; memory operatively coupled to the processor; a microphone operatively coupled to the processor; a speaker operatively coupled to the processor; and circuitry that mutes the speaker based on detection of voices via the microphone. In such an example, the circuitry to mute the speaker can include circuitry to detect two different voices via the microphone.

As an example, a system can include a speaker or a speaker output and circuitry that mutes the speaker or the speaker output based on detection of voices via a microphone or a microphone input; a vibrator and circuitry that disables the vibrator based on detection of voices via a microphone or a microphone input; and/or a display or a display output and circuitry that disables the display or the display output based on detection of voices via a microphone or a microphone input.

As an example, a system can include an application executable by a processor where the application is configured to issue a sound via a speaker (e.g., or speaker output) in response to an event and where circuitry prevents issuance of the sound via the speaker responsive to detection of voices (e.g., two different voices). In such an example, the application may be an email application and the event may be receipt of an email; the application may be a phone application and the event may be receipt of a phone call; the event may be an update to code for the application (e.g., that issues an update notice, a restart notice, etc.); and/or the application may be an instant messaging application and the event may be receipt of a message.

As an example, a speaker for outputting sound may be an external speaker, for example, operatively coupled to a wired (e.g., speaker jack) and/or a wireless output. For example, a speaker may be configured for receipt of wireless transmissions such as, for example, BLUETOOTH® transmissions, WiFi transmission, etc.

As an example, circuitry may be configured to unmute a speaker (e.g., audio circuitry, a speaker output, etc.) responsive to cessation of voices (e.g., for a period of time). As an example, where circuitry mutes a speaker responsive to detection of two voices, such circuitry may unmute the speaker responsive to detection of less than two voices for a period of time.

As an example, a method can include detecting two different voices via a microphone of a device; and responsive to the detecting, muting a speaker of the device. In such an example, the method may include unmuting the speaker of the device responsive to detecting via the microphone, for a predefined period of time, a sound level below a sound level threshold. As an example, a method may include unmuting a speaker of a device responsive to detecting via a microphone, for a predefined period of time, a single voice.

As an example, a method can include muting a speaker for audio notification events generated by an application executing on a device responsive to detection of two different voices (e.g., indicative of a meeting, etc.). In such an example, the application may be an email application, a phone application, an instant messaging application or other application configured to call for issuance of a notice or notices.

As an example, a method may provide for controlling a device or a system where the device or system can include a speaker or a speaker output and circuitry that mutes the speaker or the speaker output based on detection of voices via a microphone or a microphone input; a vibrator and circuitry that disables the vibrator based on detection of voices via a microphone or a microphone input; and/or a display or a display output and circuitry that disables the display or the display output based on detection of voices via a microphone or a microphone input.

As an example, one or more computer-readable storage media can include processor-executable instructions to instruct an information handling system to: detect voices via a microphone of the information handling system; and responsive to the detection of the voices, mute a speaker of the information handling system. In such an example, instructions may be included to unmute the speaker of the information handling system responsive to detection via the microphone, for a predefined period of time, a sound level below a sound level threshold. As an example, one or more computer-readable storage media may include instructions to instruct an information handling system to detect at least two different voices, for example, for purposes of transitioning to a state or maintaining a state. In such an example, a state may be a meeting state that configures an information handling system to be “muted” during a meeting (e.g., in a silent state).

As an example, one or more computer-readable storage media can include processor-executable instructions to instruct an information handling system to: detect a voice via a microphone of the information handling system; decide whether the voice corresponds to that of an account holder of the information handling system; and, where the detected voice does not correspond to that of the account holder, mute a speaker of the information handling system. For example, instructions may respond to a decision that a detected voice does not correspond to an account holder by muting a speaker (e.g., a speaker output, etc.). As an example, one or more computer-readable storage medium may include instructions to instruct an information handling system to unmute a speaker of the information handling system responsive to detection via a microphone, for a predefined period of time, a sound level below a sound level threshold. As an example, one or more computer-readable storage media may include instructions to instruct an information handling system to detect two different voices and, for example, instructions to mute a speaker of the information handling system responsive to detection of two different voices.

As described herein, various acts, steps, etc., may be implemented as instructions stored in one or more computer-readable storage media. For example, one or more computer-readable storage media can include computer-executable (e.g., processor-executable) instructions to instruct a device. A computer-readable medium may be a computer-readable medium that is not a carrier wave.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions. Such circuitry may optionally rely on one or more computer-readable media that includes computer-executable instructions. As described herein, a computer-readable medium may be a storage device (e.g., a memory chip, a memory card, a storage disk, etc.) and referred to as a computer-readable storage medium.

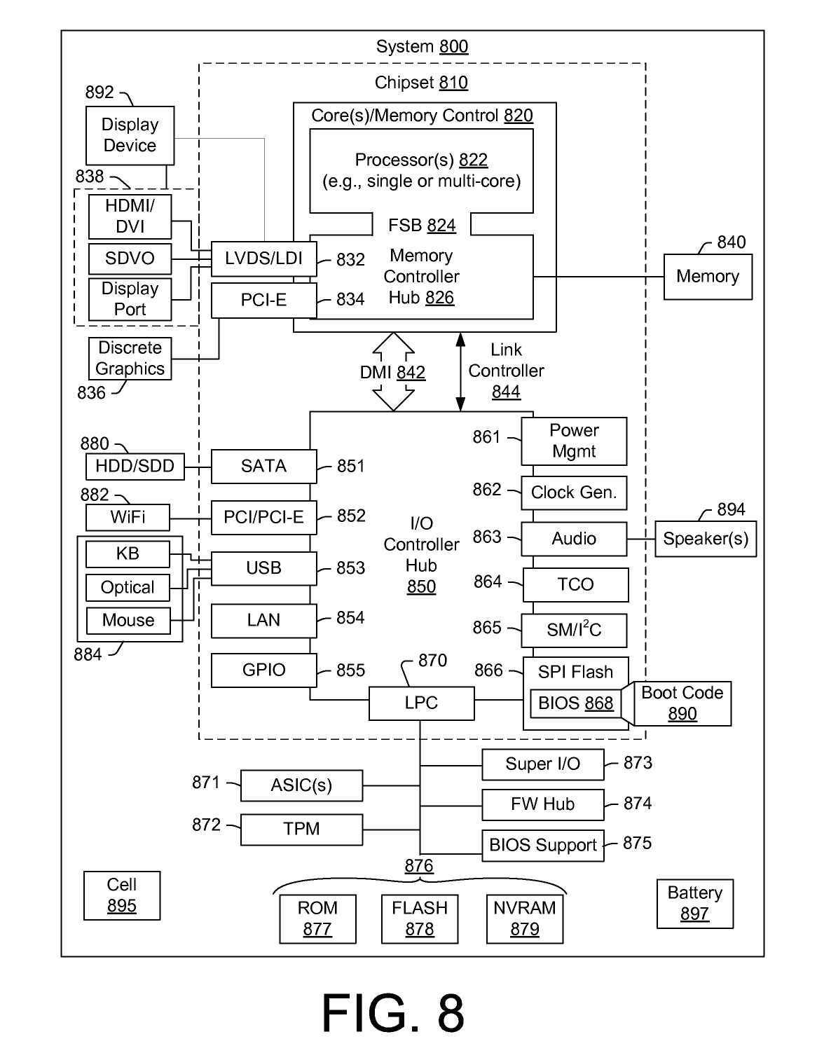

While various examples of circuits or circuitry have been discussed, FIG. 8 depicts a block diagram of an illustrative computer system 800. The system 800 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a satellite, a base, a server or other machine may include other features or only some of the features of the system 800. As an example, a device such as one of the devices of FIG. 6 may include at least some of the features of the system 800.

As shown in FIG. 8, the system 800 includes a so-called chipset 810. A chipset refers to a group of integrated circuits, or chips, that are designed (e.g., configured) to work together. Chipsets are usually marketed as a single product (e.g., consider chipsets marketed under the brands INTEL®, AMD®, etc.).

In the example of FIG. 8, the chipset 810 has a particular architecture, which may vary to some extent depending on brand or manufacturer. The architecture of the chipset 810 includes a core and memory control group 820 and an I/O controller hub 850 that exchange information (e.g., data, signals, commands, etc.) via, for example, a direct management interface or direct media interface (DMI) 842 or a link controller 844. In the example of FIG. 8, the DMI 842 is a chip-to-chip interface (sometimes referred to as being a link between a “northbridge” and a “southbridge”).

The core and memory control group 820 include one or more processors 822 (e.g., single core or multi-core) and a memory controller hub 826 that exchange information via a front side bus (FSB) 824. As described herein, various components of the core and memory control group 820 may be integrated onto a single processor die, for example, to make a chip that supplants the conventional “northbridge” style architecture.

The memory controller hub 826 interfaces with memory 840. For example, the memory controller hub 826 may provide support for DDR SDRAM memory (e.g., DDR, DDR2, DDR3, etc.). In general, the memory 840 is a type of random-access memory (RAM). It is often referred to as “system memory”.

The memory controller hub 826 further includes a low-voltage differential signaling interface (LVDS) 832. The LVDS 832 may be a so-called LVDS Display Interface (LDI) for support of a display device 892 (e.g., a CRT, a flat panel, a projector, etc.). A block 838 includes some examples of technologies that may be supported via the LVDS interface 832 (e.g., serial digital video, HDMI/DVI, display port). The memory controller hub 826 also includes one or more PCI-express interfaces (PCI-E) 834, for example, for support of discrete graphics 836. Discrete graphics using a PCI-E interface has become an alternative approach to an accelerated graphics port (AGP). For example, the memory controller hub 826 may include a 16-lane (×16) PCI-E port for an external PCI-E-based graphics card. A system may include AGP or PCI-E for support of graphics. As described herein, a display may be a sensor display (e.g., configured for receipt of input using a stylus, a finger, etc.). As described herein, a sensor display may rely on resistive sensing, optical sensing, or other type of sensing.

The I/O hub controller 850 includes a variety of interfaces. The example of FIG. 8 includes a SATA interface 851, one or more PCI-E interfaces 852 (optionally one or more legacy PCI interfaces), one or more USB interfaces 853, a LAN interface 854 (more generally a network interface), a general purpose I/O interface (GPIO) 855, a low-pin count (LPC) interface 870, a power management interface 861, a clock generator interface 862, an audio interface 863 (e.g., for speakers 894), a total cost of operation (TCO) interface 864, a system management bus interface (e.g., a multi-master serial computer bus interface) 865, and a serial peripheral flash memory/controller interface (SPI Flash) 866, which, in the example of FIG. 8, includes BIOS 868 and boot code 890. With respect to network connections, the I/O hub controller 850 may include integrated gigabit Ethernet controller lines multiplexed with a PCI-E interface port. Other network features may operate independent of a PCI-E interface.

The interfaces of the I/O hub controller 850 provide for communication with various devices, networks, etc. For example, the SATA interface 851 provides for reading, writing or reading and writing information on one or more drives 880 such as HDDs, SDDs or a combination thereof. The I/O hub controller 850 may also include an advanced host controller interface (AHCI) to support one or more drives 880. The PCI-E interface 852 allows for wireless connections 882 to devices, networks, etc. The USB interface 853 provides for input devices 884 such as keyboards (KB), one or more optical sensors, mice and various other devices (e.g., microphones, cameras, phones, storage, media players, etc.). On or more other types of sensors may optionally rely on the USB interface 853 or another interface (e.g., I²C, etc.). As to microphones, the system 800 of FIG. 8 may include hardware (e.g., audio card) appropriately configured for receipt of sound (e.g., user voice, ambient sound, etc.).

In the example of FIG. 8, the LPC interface 870 provides for use of one or more ASICs 871, a trusted platform module (TPM) 872, a super I/O 873, a firmware hub 874, BIOS support 875 as well as various types of memory 876 such as ROM 877, Flash 878, and non-volatile RAM (NVRAM) 879. With respect to the TPM 872, this module may be in the form of a chip that can be used to authenticate software and hardware devices. For example, a TPM may be capable of performing platform authentication and may be used to verify that a system seeking access is the expected system.

The system 800, upon power on, may be configured to execute boot code 890 for the BIOS 868, as stored within the SPI Flash 866, and thereafter processes data under the control of one or more operating systems and application software (e.g., stored in system memory 840). An operating system may be stored in any of a variety of locations and accessed, for example, according to instructions of the BIOS 868. Again, as described herein, a satellite, a base, a server or other machine may include fewer or more features than shown in the system 800 of FIG. 8. Further, the system 800 of FIG. 8 is shown as optionally include cell phone circuitry 895, which may include GSM, CDMA, etc., types of circuitry configured for coordinated operation with one or more of the other features of the system 800. Also shown in FIG. 8 is battery circuitry 897, which may provide one or more battery, power, etc., associated features (e.g., optionally to instruct one or more other components of the system 800). As an example, a SMBus may be operable via a LPC (see, e.g., the LPC interface 870), via an I²C interface (see, e.g., the SM/I²C interface 865), etc.

### CONCLUSION

Although examples of methods, devices, systems, etc., have been described in language specific to structural features and/or methodological acts, it is to be understood that the subject matter defined in the appended claims is not necessarily limited to the specific features or acts described. Rather, the specific features and acts are disclosed as examples of forms of implementing the claimed methods, devices, systems, etc.

What is claimed is:

1. A system comprising:
a processor;
memory operatively coupled to the processor;
a microphone operatively coupled to the processor;
a speaker operatively coupled to the processor; and
circuitry that mutes the speaker based on detection of voices via the microphone.

2. The system of claim 1 wherein the circuitry to mute the speaker comprises circuitry to detect two different voices via the microphone.

3. The system of claim 1 further comprising a vibrator and circuitry that disables the vibrator based on detection of voices via the microphone.

4. The system of claim 1 further comprising a display and circuitry that disables the display based on detection of voices via the microphone.

5. The system of claim 3 further comprising a display and circuitry that disables the display based on detection of voices via the microphone.

6. The system of claim 1 wherein the system comprises an application executable by the processor wherein the application is configured to issue a sound via the speaker in response to an event and wherein the circuitry prevents issuance of the sound via the speaker.

7. The system of claim 6 wherein the application comprises an email application and wherein the event comprises receipt of an email.

8. The system of claim 6 wherein the application comprises a phone application and wherein the event comprises receipt of a phone call.

9. The system of claim 6 wherein the event comprises an update to code for the application.

10. The system of claim 6 wherein the application comprises an instant messaging application and wherein the event comprises receipt of a message.

11. The system of claim 1 wherein the speaker comprises an external speaker.

12. The system of claim 1 wherein the circuitry is configured to unmute the speaker responsive to cessation of the voices.

13. A method comprising:
detecting two different voices via a microphone of a device; and
responsive to the detecting, muting a speaker of the device.

14. The method of claim 13 further comprising unmuting the speaker of the device responsive to detecting via the microphone, for a predefined period of time, a sound level below a sound level threshold.

15. The method of claim 13 further comprising unmuting the speaker of the device responsive to detecting via the microphone, for a predefined period of time, a single voice.

16. The method of claim 13 wherein the muting comprises muting the speaker for audio notification events generated by an application executing on the device.

17. The method of claim 16 wherein the application comprises an email application.

18. One or more computer-readable storage media comprising processor-executable instructions to instruct an information handling system to:
detect a voice via a microphone of the information handling system;
decide whether the voice corresponds to that of an account holder of the information handling system; and
where the detected voice does not correspond to that of the account holder, mute a speaker of the information handling system.

19. The one or more computer-readable storage media of claim 18 comprising processor-executable instructions to instruct an information handling system to unmute the speaker of the information handling system responsive to detection via the microphone, for a predefined period of time, a sound level below a sound level threshold.

20. The one or more computer-readable storage media of claim 18 wherein the instructions to instruct an information handling system to detect a voice comprise instructions to detect two different voices and further comprising instructions to mute the speaker of the information handling system responsive to detection of two different voices.
